(19) United States
(12) Patent Application Publication
(10) Pub. No.: US 2008/0189525 A1
(43) Pub. Date: Aug. 7, 2008

(54) IMPLEMENTING A TWO PHASE OPEN FIRMWARE DRIVER IN ADAPTER FCODE

(76) Inventors: David Lee Randall, Leander, TX (US); Muhamed Sadic, Cedar Park, TX (US); Colleen Renee Stouffer, Austin, TX (US); Mark Walz Wenning, Cedar Park, TX (US)

Correspondence Address: IBM CORP (YA);C/O YEE & ASSOCIATES PC, P.O. BOX 802333, DALLAS, TX, 75380, US

(21) Appl. No.: 11/550,139

(22) Filed: Oct. 17, 2006

(51) Int. Cl. G06F 1/00; G06F 9/312

(52) U.S. Cl. 712/225; 713/1; 712/E09.033

(57) ABSTRACT

A computer implemented method, data processing system, and computer usable program code are provided for implementing a two phase open firmware driver. A computer system probes a device for a dummy image that uses open firmware code in a compiled format. The computer system executes the dummy image. The dummy image has a dummy OPEN method and minimal properties for the device. The dummy OPEN method byte-loads a full image that uses open firmware code in a compiled format and transfers control to an OPEN method contained in the full image. The computer system loads the dummy OPEN method and minimal properties into a memory in the computer system.

### BACKGROUND OF THE INVENTION

1. Field of the Invention

The present invention relates generally to FCode firmware. More particularly, the invention pertains to a computer implemented method, data processing system, and computer usable program code for implementing a two phase open firmware driver in adapter FCode firmware.

2. Description of the Related Art

It is common for a computer system to be provided with firmware of a type that controls the computer before a computer operating system has begun execution. Firmware is software that is embedded in a hardware device. Firmware is often provided on flash ROMs or as a binary image file that can be uploaded onto existing hardware by a user. The main tasks of such firmware are to test the computer hardware and to start up or boot the operating system. However, in an open-systems environment, the task of loading the operating system can be significantly complicated by the presence of user installed I/O devices. Many I/O devices have hardware-independent firmware known as open firmware. Open firmware uses a code that is compiled into FCode rather than the machine language of any particular computer architecture. FCode is a computer programming language defined by IEEE Standard 1275-1994. FCode is semantically similar to ANS Forth but is encoded as a sequence of binary byte codes representing a defined set of Forth definitions. Thus, as a result, open firmware code included in an I/O card or other device can be executed by any computer system that uses open firmware.

When an operating system is powered on, platform system firmware scans all of the installed I/O devices and attempts to load an FCode image from the card and execute the FCode image. An FCode image for each installed I/O device is loaded into memory, and portions are executed whether the device is used or not. Loading the FCode image for each I/O device takes time and uses memory space. Another issue is that some current I/O devices have a significant power-on/configuration time. Currently, the OPEN method must start this process and may wait up to several minutes before the I/O device is ready for use.

### SUMMARY OF THE INVENTION

The illustrative embodiments provide a computer implemented method, data processing system, and computer usable program code for implementing a two phase open firmware driver. The illustrative embodiments probe, by a computer system, a device for a dummy image that uses open firmware code in a compiled format. The illustrative embodiments execute, by a computer system, the dummy image. The dummy image comprises a dummy OPEN method and minimal properties for the device. The dummy OPEN method byte-loads a full image that uses open firmware code in a compiled format and transfers control to an OPEN method contained in the full image. The illustrative embodiments load, by a computer system, the dummy OPEN method and minimal properties into a memory in the computer system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a pictorial representation of a data processing system in which the illustrative embodiments may be implemented;

FIG. 2 depicts a block diagram of a data processing system in which the illustrative embodiments may be implemented;

FIG. 3 illustrates exemplary FCode images in accordance with an illustrative embodiment;

FIG. 4 depicts a flowchart of the operation of implementing a dummy open firmware driver in adapter FCode in accordance with an illustrative embodiment; and

FIG. 5 depicts a flowchart of the operation of implementing a full open firmware driver in adapter FCode in accordance with an illustrative embodiment.

### DETAILED DESCRIPTION OF THE PREFERRED EMBODIMENT

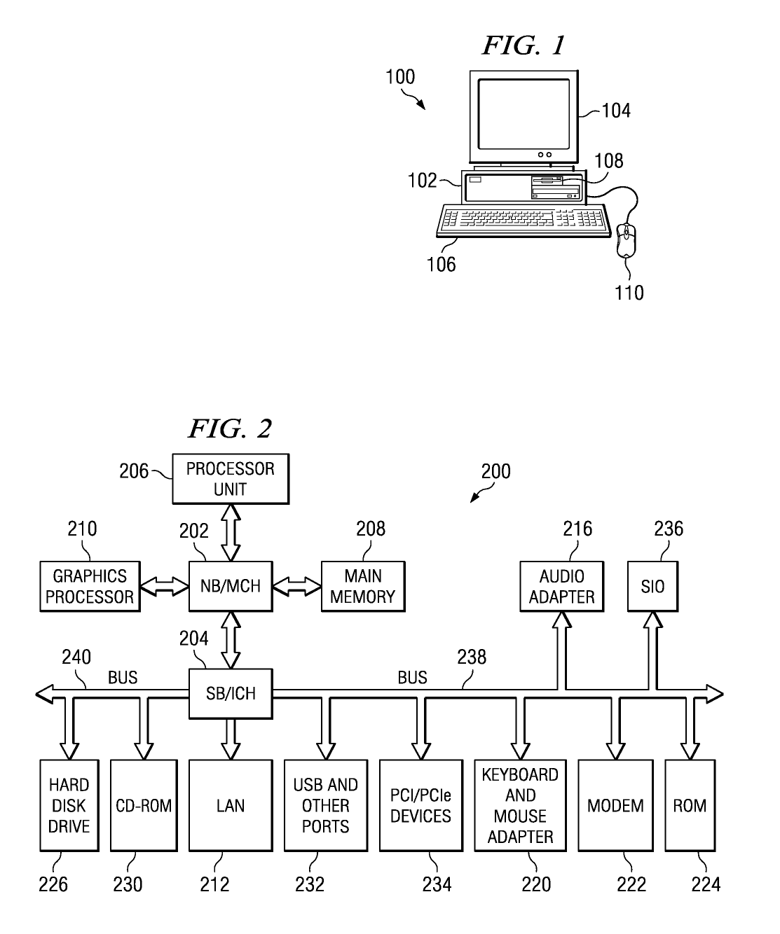

The illustrative embodiments provide for implementing a two phase open firmware driver in adapter FCode. With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described, with respect to the depicted embodiments, may be performed in a data processing system, such as data processing system 100 shown in FIG. 1 or data processing system 200 shown in FIG. 2.

The illustrative embodiments provide two FCode images on an I/O device. The FCode images are open firmware code images in compiled formats. The first FCode image is a “dummy open” image that will load at probe time, and the second FCode image is a full image that will not be loaded until the I/O device is actually OPENed. At probe time, the dummy open FCode image will be loaded into memory, which will create the minimum required properties and a “dummy OPEN” method. If, in the course of normal system operation, the I/O device is opened for use, the dummy OPEN method is a process that will byte-load the full image and transfer control to an OPEN method contained in the full image. The OPEN method is a process “opens” or places a target, such as a device, node, or package, in a condition or state to allow the target to be accessed. The advantage of the illustrative embodiments over previous inventions is that no system firmware upgrade is required. The FCode image implementing the new process is on the I/O device and can be hot-plug installed with little or no effect on system operation.

At computer power-up or probe time, the dummy driver code in an FCode image will be executed. If, in the course of normal system operation, the I/O device is opened for use, the dummy OPEN method loaded into memory at probe time will:
byte-load the full driver code located in the FCode image into the memory of the computer system, and
transfer control to an OPEN method contained in the full driver code.

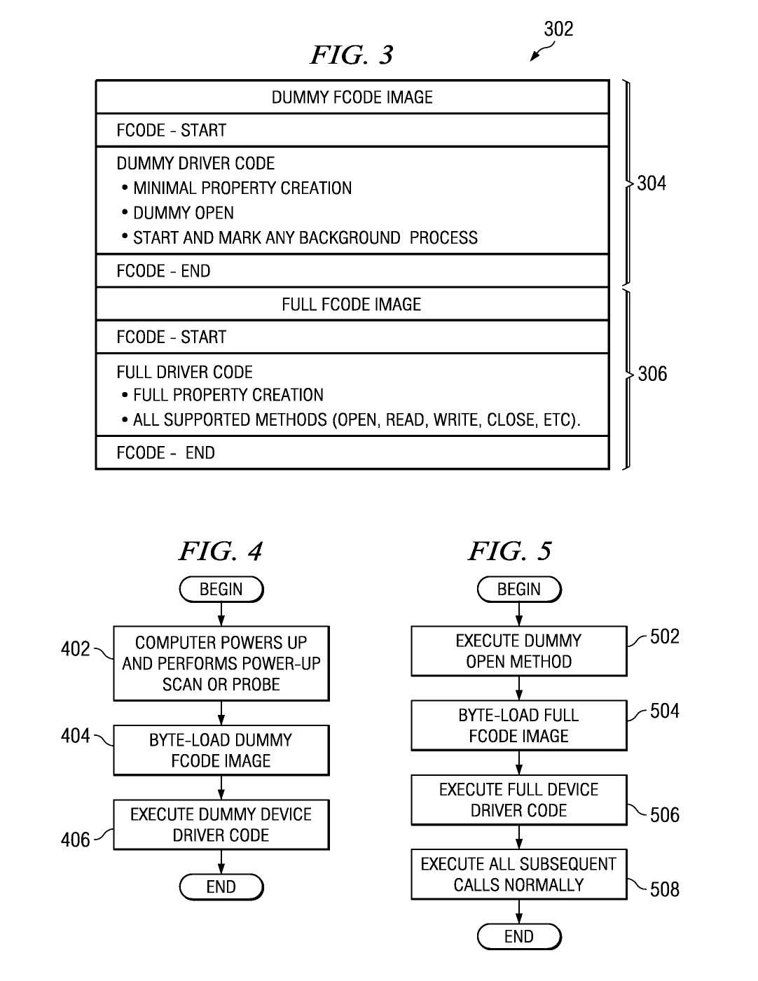

FIG. 3 illustrates exemplary FCode images in accordance with an illustrative embodiment. FCode images 302 are comprised of dummy FCode image 304 and full FCode image 306. At computer power-up or probe time, the I/O devices are scanned or probed, which is referred to as power-up scan or probe time. During probe time, dummy FCode image 304 will be byte-loaded and executed. Dummy FCode image 304 comprises dummy driver code that:
creates a new device node,
creates a defer OPEN function pointer,
creates a minimum number of properties required by the operating system,
creates a dummy OPEN method,
sets the defer OPEN function pointer to point to the dummy OPEN method, and
starts any power-up/configuration processes in the background, if applicable.
   On the very first OPEN of installed dummy driver code, the dummy OPEN method is executed. The dummy OPEN method will:
byte-load full FCode image 306, which will create the “normal” methods, such as OPEN, CLOSE, READ, WRITE, etc.,
execute the full OPEN method in full FCode image 306, and set the full OPEN method as the defer OPEN,
the full OPEN method will then check the status of any background processes and handle them accordingly, and
all subsequent calls to OPEN, READ, WRITE, etc. will now work normally.

FIG. 4 depicts a flowchart of the operation of implementing a dummy open firmware driver in adapter FCode in accordance with an illustrative embodiment. As the operation begins, a computer system performs a power-up scan or probe of all the installed I/O devices (step 402). Next, the probe of a particular I/O device which comprises a dummy FCode image byte-loads the dummy FCode image (step 404). A dummy device driver associated with the dummy FCode image then executes dummy device driver code (step 406), with the process terminating thereafter. The dummy device driver code may include one or more of the following instructions to:
create a new device node,
create a defer OPEN function pointer,
create a minimum number of properties required by the operating system,
create a dummy OPEN method,
set the defer OPEN function pointer to point to the dummy OPEN method, and
start any power-up/configuration processes in the background, if applicable.

FIG. 5 depicts a flowchart of the operation of implementing a full open firmware driver in adapter FCode in accordance with an illustrative embodiment. If, in the course of normal system operation, the I/O device is opened for use by executing the dummy OPEN method (step 502), the dummy OPEN method byte-loads the full FCode image (step 504). A full device driver associated with the full FCode image then executes full device driver code (step 506). The full device driver code may include one or more of the following instructions:
check status of background processes,
create the “normal” methods, such as OPEN, CLOSE, READ, WRITE, etc.,
execute the full OPEN method in the full FCode image, and
set the full OPEN method as defer OPEN.
   Once the full device driver code is executed, all subsequent calls to OPEN, READ, WRITE, etc. execute normally (step 508), with the operation terminating thereafter.

Thus, the illustrative embodiments provide for a two phase open firmware driver. A computer system probes device for a dummy FCode image. The computer system executes the dummy FCode image. The dummy FCode image has a dummy open method and minimal properties for the device. The dummy open method byte-loads a full FCode image and transfers control to an open method contained in the full FCode image. The computer system loads the dummy open method and minimal properties into a memory in the computer system. If the computer system detects a call for the device, the dummy open method is executed. The full FCode image is byte-loaded into the memory in the computer system. The full FCode image has an open method and control is transferred to the open method.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for implementing a two phase open firmware driver, the computer implemented method comprising:
probing, by a computer system, a device for a dummy image that uses open firmware code in a compiled format;
executing, by the computer system, the dummy image, wherein the dummy image comprises a dummy OPEN method and minimal properties for the device and wherein the dummy OPEN method byte-loads a full image that uses open firmware code in a compiled format and transfers control to an OPEN method contained in the full image; and
loading, by the computer system, the dummy OPEN method and the minimal properties into a memory in the computer system.

2. The computer implemented method of claim 1, further comprising:
detecting, by the computer system, a call for the device;
responsive to the call for the device, executing, by the computer system, the dummy OPEN method;
byte-loading, by the computer system, the full image into the memory in the computer system, wherein the full image comprises the OPEN method; and
transferring the control, by the computer system, to the OPEN method.

3. The computer implemented method of claim 1, wherein loading the dummy OPEN method and the minimal properties into the memory in the computer system further comprises:
executing, by the computer system, one or more of creating a new device node, creating a defer OPEN method, setting the defer OPEN method, or start any power-up/configuration processes in a background.

4. The computer implemented method of claim 2, wherein byte-loading the full image into the memory in the computer system further comprises:
executing, by the computer system, one or more of checking a status of background processes or setting the OPEN method as defer OPEN.

5. The computer implemented method of claim 1, wherein the device is an I/O adapter for use with the computer system.

6. The computer implemented method of claim 1, wherein the device is a plug-in device.

7. The computer implemented method of claim 1, wherein the open firmware code in the compiled format is FCode.

8. A data processing system comprising:
a bus system;
a device connected to the bus system;
a communications system connected to the bus system;
a memory connected to the bus system, wherein the memory includes a set of instructions; and
a processing unit connected to the bus system, wherein the processing unit executes the set of instructions to probe, by the data processing system, the device for a dummy image that uses open firmware code in a compiled format; execute, by the data processing system, the dummy image, wherein the dummy image comprises a dummy OPEN method and minimal properties for the device and wherein the dummy OPEN method byte-loads a full image that uses open firmware code in a compiled format and transfers control to an OPEN method contained in the full image; and load, by the data processing system, the dummy OPEN method and the minimal properties into the memory in the data processing system.

9. The data processing system of claim 8, wherein the processing unit executes the set of instructions to detect, by the data processing system, a call for the device; executing, by the data processing system, the dummy OPEN method in response to the call for the device; byte-load, by the data processing system, the full image into the memory in the data processing system, wherein the full image comprises the OPEN method; and transfer the control, by the data processing system, to the OPEN method.

10. The data processing system of claim 8, wherein the processing unit executing the set of instructions to load the dummy OPEN method and the minimal properties into the memory in the data processing system further comprises the processing unit executes the set of instructions to execute, by the data processing system, one or more of creating a new device node, creating a defer OPEN method, setting the defer OPEN method, or start any power-up/configuration processes in a background.

11. The data processing system of claim 9, wherein the processing unit executing the set of instructions to byte-load the full image into the memory in the data processing system further comprises the processing unit executes the set of instructions to execute, by the data processing system, one or more of checking a status of background processes or setting the OPEN method as defer OPEN.

12. The data processing system of claim 8, wherein the device is an I/O adapter for use with the data processing system.

13. The data processing system of claim 8, wherein the device is a plug-in device.

14. A computer program product comprising:
a computer usable medium including computer usable program code for implementing a two phase open firmware driver, the computer program product including:
computer usable program code for probing, by a computer system, a device for a dummy image that uses open firmware code in a compiled format;
computer usable program code for executing, by the computer system, the dummy image, wherein the dummy image comprises a dummy OPEN method and minimal properties for the device and wherein the dummy OPEN method byte-loads a full image that uses open firmware code in a compiled format and transfers control to an OPEN method contained in the full image; and
computer usable program code for loading, by the computer system, the dummy OPEN method and the minimal properties into a memory in the computer system.

15. The computer program product of claim 14, further including:
computer usable program code for detecting, by the computer system, a call for the device;
computer usable program code for executing, by the computer system, the dummy OPEN method in response to the call for the device;
computer usable program code for byte-loading, by the computer system, the full image into the memory in the computer system, wherein the full image comprises the OPEN method; and
computer usable program code for transferring the control, by the computer system, to the OPEN method.

16. The computer program product of claim 14, wherein the computer usable program code for loading the dummy OPEN method and the minimal properties into the memory in the computer system further includes:
computer usable program code for executing, by the computer system, one or more of creating a new device node, creating a defer OPEN method, setting the defer OPEN method, or start any power-up/configuration processes in a background.

17. The computer program product of claim 15, wherein the computer usable program code for byte-loading the full image into the memory in the computer system further includes:
computer usable program code for executing, by the computer system, one or more of checking a status of background processes or setting the OPEN method as defer OPEN.

18. The computer program product of claim 14, wherein the device is an I/O adapter for use with the computer system.

19. The computer program product of claim 14, wherein the device is a plug-in device.

20. The computer program product of claim 14, wherein the open firmware code in the compiled format is FCode.
